(19) United States
(12) Patent Application Publication
(10) Pub. No.: US 2009/0260183 A1
(43) Pub. Date: Oct. 22, 2009

(54) HINGE ASSEMBLY FOR FOLDABLE ELECTRONIC DEVICES

(75) Inventors: CHIA-HUA CHEN, Shindian (TW); MING ZHENG, Shenzhen City (CN); HAI-BO TAN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/168,237

(22) Filed: Jul. 7, 2008

(30) Foreign Application Priority Data
Apr. 22, 2008 (CN) 200810301247.1

(51) Int. Cl. E05D 3/02

(52) U.S. Cl. 16/223; 16/274

(57) ABSTRACT

A hinge assembly includes a shaft (21), a cam member, a resilient member (23) and a cam. The cam member has a cam portion (212), and the cam member is fixed to the shaft. The resilient member is mounted on one end of the shaft. The cam has a cam surface (222), and the cam surface defines a plurality of grooves (225) for storing lubricate oils, and the cam is slidable and rotatable relative to the shaft. The cam surface is engaged with the cam portion by the resilient member.

### BACKGROUND

1. Field of the Invention

The present invention relates to hinge assemblies and, particularly, to hinge assemblies for foldable electronic devices, such as mobile phones and portable computers.

2. Description of Related Art

Presently, perhaps the most popular portable electronic device in the marketplace is the foldable mobile phone, which generally includes a cover section and a body section. The cover section and the body section are rotatably interconnected through a hinge assembly, for switching the telephone between an in-use position and a closed position.

A typical hinge assembly used in small foldable electronic devices includes a shaft, a cam with a cam surface, a follower with a latching cam surface and a spring. The follower and the cam are placed around the shaft, and the spring provides an elastic force to keep the latching cam surface and the cam surface contact each other at all times. This type hinge assembly is that the cam surface of the cam moves relative to the latching cam surface by overcoming the elastic force of the spring, thereby realizing the cover to be opened or closed relative to the body.

However, since the cam surface contacts with the latching cam surface at all times, friction force is likely to occurs between the cam surface and the latching cam surface. The friction force can potentially damage the cam surface and the latching cam surface, thus reducing the life span of the hinge assembly.

Therefore, there is room for improvement within the art.

### BRIEF DESCRIPTION OF THE DRAWINGS

Many aspects of the present hinge assembly can be better understood with reference to the following drawings. The components in the drawings are not necessarily drawn to scale, the emphasis instead being placed upon clearly illustrating the principles of the present hinge assembly. Moreover, in the drawings, like reference numerals designate corresponding parts throughout the several views, in which:

FIG. 1 is an exploded, isometric view of an exemplary hinge assembly;

FIG. 2 is similar to FIG. 1, but viewed from another angle;

FIG. 3 is an assembled, isometric view of the exemplary hinge assembly shown in FIG. 2; and;

FIG. 4 is an isometric view of a foldable electronic device with the exemplary hinge assembly shown in FIG. 1.

### DETAILED DESCRIPTION OF THE EMBODIMENTS

The present hinge assembly is suitable for a foldable electronic device such as a flip-type mobile phone, for pivotably coupling a cover section and a body section. It is to be understood, however, that the hinge assembly could be advantageously used in other environments (e.g. cabinet doors).

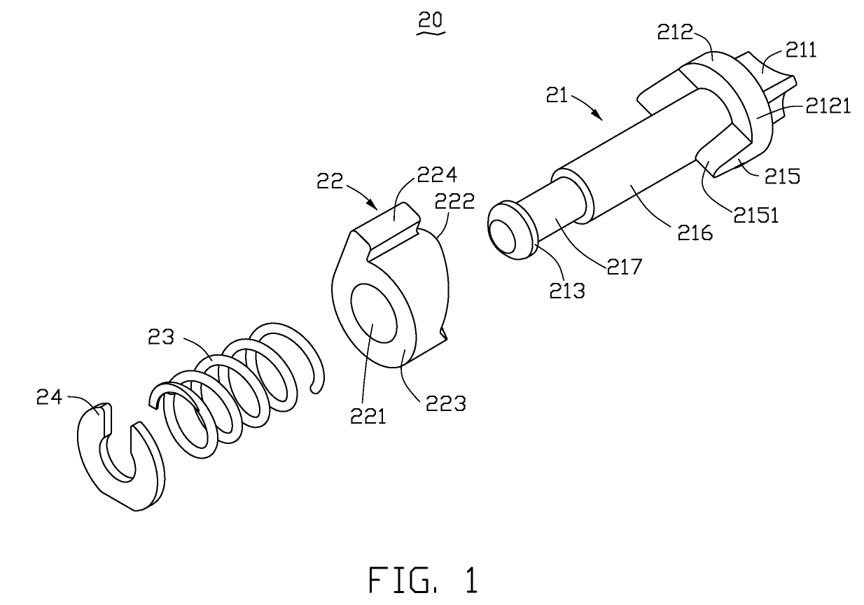

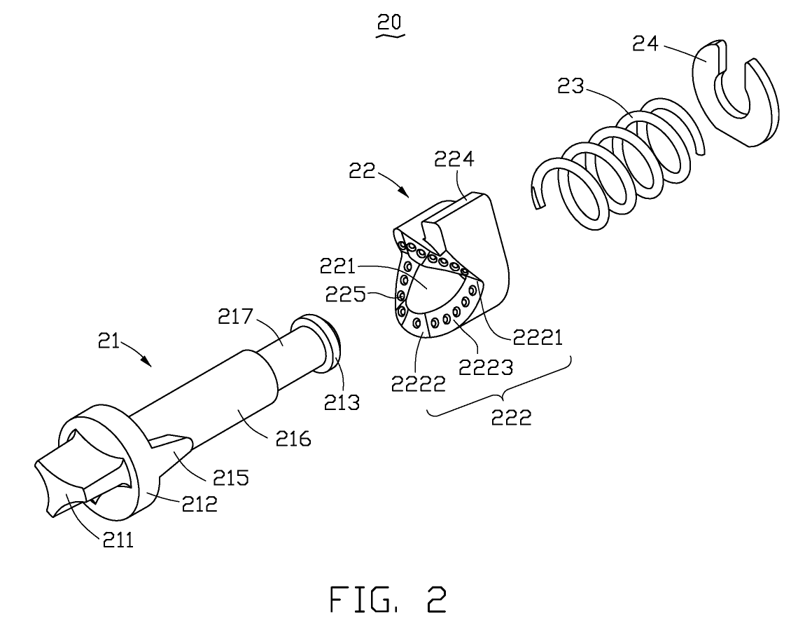

Referring to FIGS. 1 and 2, an exemplary hinge assembly 20 includes a main shaft 21, a follower 22, a resilient member 23, and a locking member 24.

The main shaft 21 includes a fixing portion 211, a cam portion 212, a shaft portion 216, a necked portion 217 and a positioning portion 213. The fixing portion 211, the cam portion 212, the shaft portion 216, the necked portion 217 and the positioning portion 213 are coaxially arranged with each other. The fixing portion 211 is substantially a deformed three-side prism, and is formed at one end of the shaft 21. The fixing portion 211 is configured for fixing with a body of a foldable electronic device. The cam portion 212 is formed on the shaft portion 216 adjacent to the fixing portion 211. The cam portion 212 includes a circular flange 2121 and a pair of protrusions 215. Each of the protrusions 215 extends from one side of the flange 2121 opposite to the fixing portion 211. The protrusions 215 are spaced apart from each other by an angle of about 180 degrees. Each protrusion 215 is substantially thump-shape, and includes a tip end 2151. A diameter of the shaft portion 216 is slightly larger than a diameter of the necked portion 217. The positioning portion 213 is formed at the other end of the shaft 21. The positioning portion 213 is a substantially circular disk and has a larger diameter than the diameter of the necked portion 217.

The follower 22 is substantially in the form of a hollow cylinder and defines a through hole 221 at the central portion thereof. The follower 22 has a cam surface 222 formed at one end, and a flat surface 223 formed at an opposite end. The cam surface 222 defines a plurality of circular grooves 225 configured for storing lubricate oils therein. The cam surface 222 has a pair of valleys 2221, and a pair of peaks 2222. Each valley 2221 with each peak 222 is connected with a slope surface 2223. The valleys 2221 and the peaks 2222 are separated from each other by an angle of about 180 degrees. A projection 224 is formed on an outer periphery of the follower 22 extending from one end to the other end. The projection 224 is configured for engaging with a cover so that the follower 22 is movable with the cover.

The resilient member 23 is preferably made of metal and is spiral-shaped (i.e. a coil spring). A diameter of the resilient member 23 is slightly larger than a diameter of the shaft portion 216 so that the resilient member 23 can be placed around the shaft portion 216.

The locking member 24 is a C-shape ring, and is used for latching with the necked portion 217 of the shaft 21.

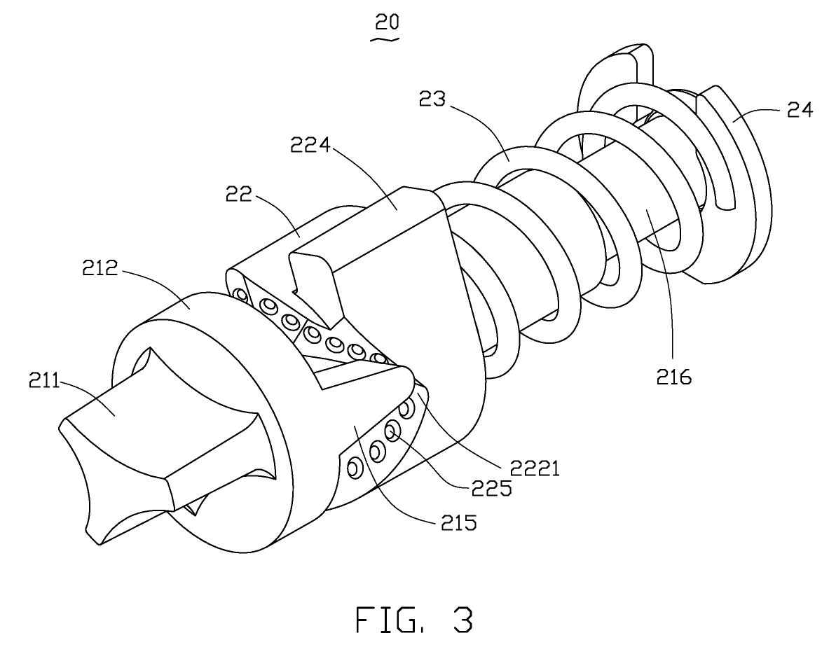

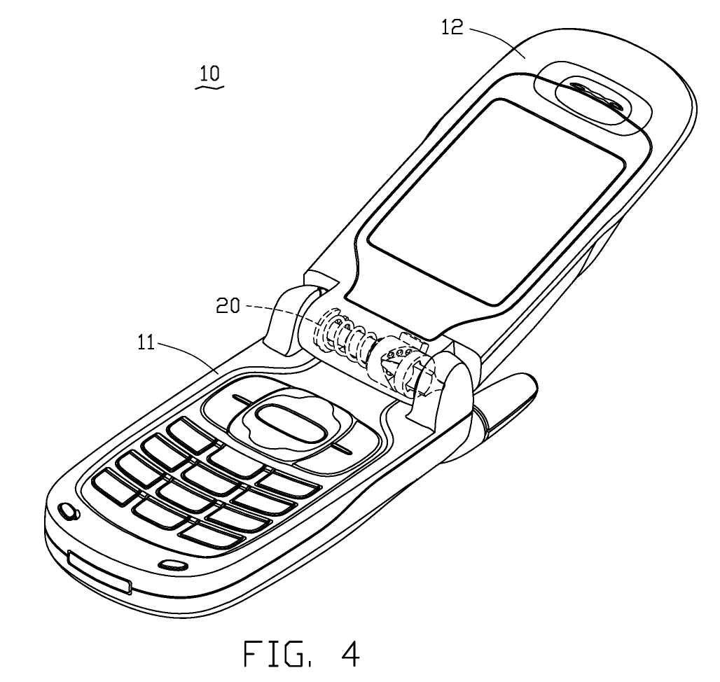

Referring to FIG. 3, in assembly of the hinge assembly 20, the shaft portion 216 is inserted through the through hole 221 of the follower 22, and the resilient member 23. The locking member 24 is locked in the necked portion 217, and resists the positioning portion 213, thereby securing the above elements on the shaft 21. One end of the resilient member 23 abuts against the positioning portion 213 and the other opposite end of the resilient member 23 abuts against the flat surface 223 of the follower 22. The cam portion 212 of the shaft 21 is engaged with the cam surface 222 of the follower 22 urged by the resilient member 23. The protrusions 215 of the cam portion 212 are received in the valleys 2221. Referring to FIG. 4, the hinge assembly 20 is assembled in a foldable electronic device 10. The foldable electronic device 10 includes a cover 12 and a body 11. The fixing portion 211 is fixed to the body 11 of the foldable electronic device 10. The projection 224 of the follower 22 is engaged with the cover 12 of the foldable electronic device 10. At an initial state, the resilient member 23 has a predetermined compressed force, and the cover 12 is held in a closed position.

To open the foldable electronic device 10, the cover 12 is manually rotated relative to the body 11 in an opening direction. The follower 22 moves together with the cover 12. During this process, the resilient member 23 is further compressed, and the valleys 2221 are moved away from the protrusions 215. The tip end 2151 of the protrusion 215 slides along the slope 2223 from the valley 2221 to the peak 2222. When the tip end 2151 of the protrusion 215 slides over the peak 2222, the cover 12 is released. The follower 22 continues to rotate in the open direction and move toward the fixing portion 211 of the shaft 21 with the assistance of the decompressed resilient member 23. The cover 12 continues to open until the protrusions 215 move into another valley 2222.

To close the foldable electronic device 10, the cover 12 is manually rotated towards the body 11 causing the follower 22 to rotate relative to the shaft 10. By the engagement between the cam surface 222 of the follower 22 and the cam portion 212 of the shaft 21, the follower 22 is pushed axially towards the locking member 24. During this process, the resilient member 23 is further compressed. When the tip end 2151 of the protrusion 215 slides over the peak 2222, the cover 12 is released. The follower 22 continues to rotate relative to the body 11 and moves towards the fixing portion 211 of the shaft 21 with the assistance of the decompressed resilient member 23. The cover 12 continues to close until the protrusion 215 moves into another valley 2222.

A main advantage of the present invention is that the grooves in the cam surface 222 store lubricate oils, thereby greatly reducing the friction produced between the cam surface 222 and the protrusions 215.

It is to be understood that the resilient member 23 may alternatively be made of another material (e.g. plastic or rubber). The resilient member 23 may alternatively have a different configuration, for example, a leaf spring or a resilient cylinder. The cam portion 212 may be separately attached to the shaft 21. The cam portion 212 may be fixed to the shaft 21 or be configured to slide with the shaft 21. The locking member 24 may be omitted. The positioning portion 213 can be configured to position the resilient member 23.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a shaft;
a cam member having a cam portion, the cam member being fixed to the shaft;
a resilient member mounted on one end of the shaft;
a cam having a cam surface, the cam surface defining a plurality of grooves for storing lubricate oils, and the cam being slidable and rotatable relative to the shaft, and the cam surface being engaged with the cam portion by the resilient member.

2. The hinge assembly as claimed in claim 1, further comprising a locking member mounted on one end of the shaft for positioning the resilient member.

3. The hinge assembly as claimed in claim 1, wherein the cam member is either integrally formed as part of the shaft or is a separate piece attached to the shaft.

4. The hinge assembly as claimed in claim 1, wherein the main shaft includes a fixing portion, a shaft portion, and a positioning portion, the fixing portion is positioned at one end of the shaft portion, and the positioning portion is formed at another end of the shaft portion.

5. A foldable electronic device, comprising:
a cover;
a body; and
a hinge assembly rotatably connecting the cover and the body, the hinge assembly comprising:
a shaft having a cam portion integrally formed together;
a follower having a cam surface defining a plurality of grooves, the cam being slidably and rotatably movable relative to the shaft, and the cam surface being engaged with the cam portion by the resilient member; and
a resilient member mounted on one end of the shaft.

6. The foldable electronic device as claimed in claim 5 wherein a projection is provided on a periphery of the cam, and the projection is configured to allow it to be being engaged with the cover so that the cam is movable relative to the cover.

7. The foldable electronic device as claimed in claim 5, wherein the cam member is either integrally formed as part of the shaft or is a separate component attached to the shaft.

8. The foldable electronic device as claimed in claim 5, wherein a fixing portion is provided at one end of the shaft, and the fixing portion is configured to allow it to be fixed to the body.

9. The foldable electronic device as claimed in claim 5, wherein the main shaft includes a fixing portion, a shaft portion, and a positioning portion, the fixing portion is positioned at one end of the shaft portion, and the positioning portion is formed at another end of the shaft portion.
